(19) United States
(12) Patent Application Publication
(10) Pub. No.: US 2022/0300399 A1
(43) Pub. Date: Sep. 22, 2022

(54) SYSTEM AND METHOD FOR USING MACHINE LEARNING FOR TEST DATA PREPARATION AND EXPECTED RESULTS PREDICTION

(71) Applicant: Cigna Intellectual Property, Inc., Wilmington, DE (US)

(72) Inventors: Jaya Prasanthi Bikkina, Overland Park, KS (US); Jessica Lerario, Suffield, CT (US); Andrew Ehle, Denver, CO (US); Vengatesh Raghunathan, Coimbatore (IN); Mukund Nekkanti, Manchester, CT (US); GirishKumar Ramesh, Chennai (IN); Thamizhazhagan Nagarajan, Kattumannar Koil (IN)

(21) Appl. No.: 17/204,280

(22) Filed: Mar. 17, 2021

(51) Int. Cl. G06F 11/36; G06K 9/62; G06N 20/00

(52) U.S. Cl. CPC G06F 11/3684; G06F 11/3688; G06F 11/3692; G06K 9/6263; G06K 9/6223; G06N 20/00

(57) ABSTRACT

A method for automatically identifying test case data includes receiving a plurality of data records from one or more data producer applications and classifying data records of the plurality of data records into test data clustering model. The method also includes receiving input indicating one or more test case requirements and generating, based at least on the one or more test case requirements and the test data clustering models, at least one test case blueprint indicating at least one test data clustering model that corresponds to the one or more test case requirements. The method also includes, in response to instructions to perform a data test corresponding to the test case requirements, using the at least one test case blueprint to populate test case data using data records corresponding to the at least one test data clustering model indicated by the at least one test case blueprint.

### TECHNICAL FIELD

This disclosure relates to test data preparation and expected results prediction, and in

### BACKGROUND

Enterprises, such as high volume pharmacies and other suitable enterprises, are increasingly relying on automated software testing suits, including functional testing and regression testing features, for testing software developed for and/or used for various functions within such enterprises. Typically, data related to such testing plays a critical role in a continuous testing, continuous integration, and continuous deployment environments, which may be increasingly useful in agile and development operations (DevOps) environments.

Increasingly, to address various data challenges, enterprises are increasingly identifying techniques that allow for relatively quick and accurate data preparation or mining. However, such techniques for preparing data relatively quickly and accurately are typically time consuming and may require relatively substantial manual effort.

### SUMMARY

This disclosure relates generally to test data preparation and expected results prediction systems and methods.

An aspect of the disclosed embodiments includes a system for automatically identifying test case data. The system includes a processor and a memory. The memory includes instructions that, when executed by the processor, cause the processor to: receive a plurality of data records from one or more data producer applications; classify, using an artificial intelligence engine that uses a machine learning model configured to classify data records, data records of the plurality of data records into test data clustering models; receive input indicating one or more test case requirements; generate, based at least on the one or more test case requirements and the test data clustering models, at least one test case blueprint indicating at least one test data clustering model that corresponds to the one or more test case requirements; and, in response to instructions to perform a data test corresponding to the test case requirements, use the at least one test case blueprint to populate test case data using data records corresponding to the at least one test data clustering model indicated by the at least one test case blueprint.

Another aspect of the disclosed embodiments includes a method for automatically identifying test case data. The method includes receiving a plurality of data records from one or more data producer applications and classifying, using an artificial intelligence engine that uses a machine learning model configured to classify data records, data records of the plurality of data records into test data clustering model. The method also includes receiving input indicating one or more test case requirements and generating, based at least on the one or more test case requirements and the test data clustering models, at least one test case blueprint indicating at least one test data clustering model that corresponds to the one or more test case requirements. The method also includes, in response to instructions to perform a data test corresponding to the test case requirements, using the at least one test case blueprint to populate test case data using data records corresponding to the at least one test data clustering model indicated by the at least one test case blueprint.

Another aspect of the disclosed embodiments includes an apparatus for automatically identifying test case data. The apparatus includes a processor and a memory. The memory includes instructions that, when executed by the processor, cause the processor to: receive a plurality of data records from one or more data producer applications; classify, using an artificial intelligence engine that uses a machine learning model configured to classify data records, data records of the plurality of data records into test data clustering models; receive input indicating one or more test case requirements; generate, based at least on the one or more test case requirements and the test data clustering models, at least one test case blueprint indicating at least one test data clustering model that corresponds to the one or more test case requirements; in response to instructions to perform a data test corresponding to the test case requirements, use the at least one test case blueprint to populate test case data using data records corresponding to the at least one test data clustering model indicated by the at least one test case blueprint; train the machine learning model using feedback corresponding to the performed data test; and, in response to receiving subsequent data records from the one or more data producer applications, classify, using the artificial intelligence using the machine learning model, the subsequent data records into the test data clustering models.

Another aspect of the disclosed embodiments includes a system for predicting expected results of at least one test case. The system includes a processor and a memory. The memory includes instructions that, when executed by the processor, cause the processor to: receive a test case that uses data records from one or more applications; predict, using an artificial intelligence engine that uses a machine learning model configured to predict test case outcomes, a test case outcome for each test cycle of the test case, the machine learning model being trained using classified actual outcomes of test cases having similar test case requirements as the test case; compare, using a test automation framework, the predicted test case outcome for each test cycle of the test case to an actual outcome for each test cycle; and generate a report indicating a result of the comparison of the predicted test case outcome for each test cycle of the test case to the actual outcome for each test cycle.

Another aspect of the disclosed embodiments includes a method for predicting expected results of at least one test case. The method includes receiving a test case that uses data records from one or more applications and predicting, using an artificial intelligence engine that uses a machine learning model configured to predict test case outcomes, a test case outcome for each test cycle of the test case, the machine learning model being trained using classified actual outcomes of test cases having similar test case requirements as the test case. The method also includes comparing, using a test automation framework, the predicted test case outcome for each test cycle of the test case to an actual outcome for each test cycle and generating a report indicating a result of the comparison of the predicted test case outcome for each test cycle of the test case to the actual outcome for each test cycle.

Another aspect of the disclosed embodiments includes an apparatus for predicting expected results of at least one test case. The apparatus includes a processor and a memory. The memory includes instructions that, when executed by the processor, cause the processor to: receive a test case that uses data records from one or more applications, the data records being classified using an unsupervised machine learning model; predict, using an artificial intelligence engine that uses a supervised machine learning model configured to predict test case outcomes, a test case outcome for each test cycle of the test case, the supervised machine learning model being trained using classified actual outcomes of test cases having similar test case requirements as the test case; compare, using a test automation framework, the predicted test case outcome for each test cycle of the test case to an actual outcome for each test cycle; generate a report indicating a result of the comparison of the predicted test case outcome for each test cycle of the test case to the actual outcome for each test cycle; and using the report, further train the supervised machine learning model.

These and other aspects of the present disclosure are disclosed in the following detailed description of the embodiments, the appended claims, and the accompanying figures.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 generally illustrates a functional block diagram of a system including a high-volume pharmacy according to the principles of the present disclosure.

FIG. 2 generally illustrates a functional block diagram of a pharmacy fulfillment device, which may be deployed within the system of FIG. 1.

FIG. 3 generally illustrates a functional block diagram of an order processing device, which may be deployed within the system of FIG. 1.

FIG. 4 generally illustrates a computing device according to the principles of the present disclosure.

FIG. 5 generally illustrates a test data classification flow according to the principles of the present disclosure.

FIG. 6 generally illustrates an expected results prediction use case according to the principles of the present disclosure.

FIG. 7 is a flow diagram generally illustrating a test data preparation method according to the principles of the present disclosure.

FIG. 8 is a flow diagram generally illustrating an expected results prediction method according to the principles of the present disclosure.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

As described, enterprises, such as high volume pharmacies and other suitable enterprises, are increasingly relying on automated software testing suits, including functional testing and regression testing features, for testing software developed for and/or used for various functions within such enterprises. Typically, data related to such testing plays a critical role in a continuous testing, continuous integration, and continuous deployment environments, which may be increasingly useful in agile (e.g., practices that involve discovering requirements and developing solutions through the collaborative effort of self-organizing and cross-functional teams and corresponding customers and/or end users) and development operations (DevOps) environments (e.g., a set of practices that combines software development (Dev) and information technology operations (Ops) with a goal to shorten systems development life cycles and provide continuous delivery with relatively high software quality). Additionally, or alternatively, automation techniques may rely on test data for execution, which may be stored in spreadsheets and/or data tables for use by the automation techniques.

Increasingly, to address various data challenges, enterprises are increasingly identifying techniques that allow for relatively quick and accurate data preparation or mining. Such techniques ay include reusing the same data repeatedly, which may not be adequate for testing systems and/or software that require new data for every test or test cycle. Another technique may include using virtual data pipelines for backup and/or restore of an application database in order to simulate providing new data for each test or test cycle. However, such techniques are typically time consuming and may require relatively substantial manual effort. For example, while such techniques may be capable of selecting data from spreadsheets and/or data tables automatically, a substantial amount of manual effort may be required for fetching proper data for specific test cases and for updating the spreadsheets and/or data tables.

Accordingly, systems and methods, such as those described herein, configured to provide automated the fetching and mapping of data corresponding to one or more automated test cases, may be desirable. In some embodiments, the systems and methods described herein may be configured to provide an automated identification of appropriate data for test cases. The systems and methods described herein may be configured to train algorithms used to identify the appropriate data for test cases, such that the algorithms are capable of using data requirements for a particular test scenario. The test scenario may include a test scenario for a high volume pharmacy or other suitable enterprise in any suitable industry. For example, test scenario may include testing a software application for processing insurance claims.

The systems and methods described herein may be configured to correlate (e.g., or tag) the identified data with the corresponding test scenario (e.g., which may then be accessed or used by an automation test application or suit through an application programming interface (API)).

In some embodiments, the systems and methods described herein may be configured to use an artificial intelligence engine using at least one machine learning model configured to identify appropriate test data for a corresponding test case (e.g., or test scenario). The machine learning model may include a supervised machine learning model or an unsupervised machine learning model.

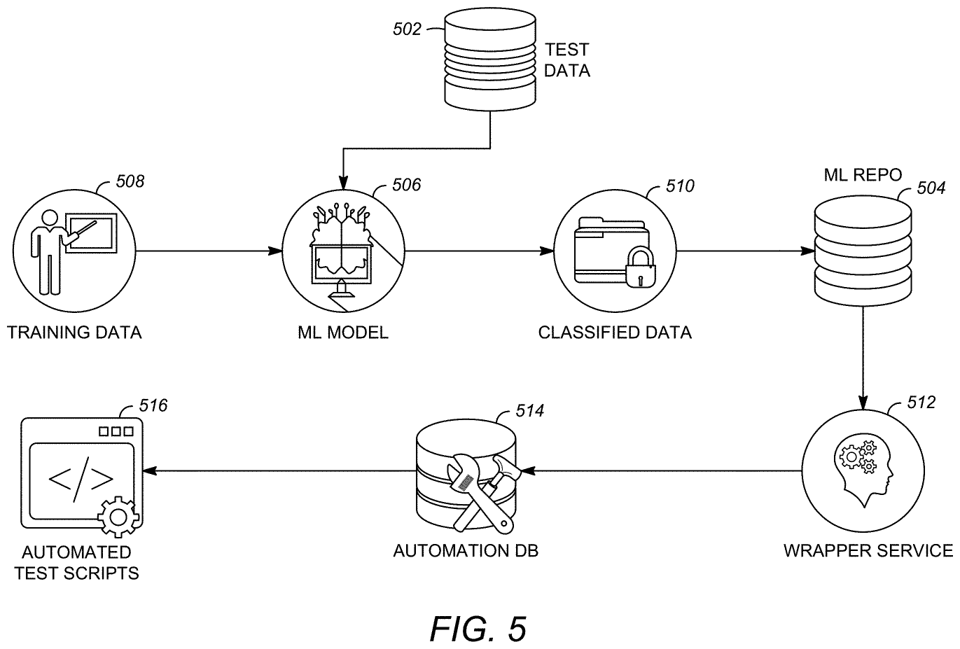

In some embodiments, the systems and methods described herein may be configured to collect data from various data sources, such as CED, CDB, PRDS, and the like. The systems and methods described herein may be configured to identify attributes required for the test scenario. The systems and methods described herein may be configured to label the data based on the known data attributes and/or rules. The systems and methods described herein may be configured to divide a corresponding dataset or test data 502, as is generally illustrated in FIG. 5, for the test scenario into training and/or test samples, respectively. The systems and methods described herein may be configured to load the test data 502 for the test scenario into a machine learning repository 504 (e.g., represented as “ML Repo” in FIG. 5) for access by the at least one machine learning model 506.

In some embodiments, the systems and methods described herein may be configured to train the machine learning model 506 (e.g., represented as “ML Model” in FIG. 5) using training data 508 (e.g. data of the test data 502 identified as training data). The systems and methods described herein may be configured to run the machine learning model 506 to classify the test data 502 as classified data 510 and store the classified data 510 to the machine learning repository 504. The systems and methods described herein may be configured to write a wrapper service 512 to store the classified data 510 in an automation database 514 (e.g., represented as “Automation DB” in FIG. 5) for access by an automation script 516.

In some embodiments, as various applications are connected with one another, the various applications rely on each other for data. Some of the various applications may ingest data into a value stream, while other applications (e.g., which may be referred to as producers or producer applications) may consume the data ingested by the consuming applications. In some embodiments, the systems and methods described herein may be configured to identify, based on a value stream mapping, attributes that the consumer applications rely on producer applications for consumer application test scenarios.

In some embodiments, the systems and methods described herein may be configured to generate individual clustering models corresponding to each producer application. The systems and methods described herein may be configured to assign a cluster number corresponding to a clustering model for each data record of the test data 502. As typical test scenarios may be complex and rely on multiple producer applications for several test cases, the systems and methods described herein may be configured to integrate the clustering models, which may be referred to as a blueprint. The systems and methods described herein may be configured to use the blueprints may be correlated (e.g., or tagged) with corresponding test scenarios. In this manner, the systems and methods described herein may be configured to tie test data, such as the test data 502, to a corresponding test scenario. The systems and methods described herein may be configured to dynamically inject the test data 502 into corresponding automation test applications or suits.

In some embodiments, the systems and methods described herein may be configured to provide continuous data using a trained automated process. The systems and methods described herein may be configured to look-up, in real time or near real time (e.g., less than 1 second or other suitable period), test data to avoid test data inconsistencies. The systems and methods described herein may be configured to provide unattended automation using single input (e.g., such as a single click or other suitable input). The systems and methods described herein may be configured to provide accuracy in mapping corresponding appropriate test data for respective test cases.

In some embodiments, the systems and methods described herein may be configured to fetch raw data from a database using various data attributes. The systems and methods described herein may be configured to cleanse the fetched data using missing values and corresponding data types. The systems and methods described herein may be configured to analyze and select a test data clustering model. The systems and methods described herein may be configured to select an algorithm for the machine learning model based on R-squared, mean squared error metrics, and/or a corresponding accuracy. The systems and methods described herein may be configured to evaluate outputs through a confusion matrix (e.g., a table having predicted and/or actual values).

In some embodiments, the systems and methods described herein may be configured to using one or more algorithms to classify the data records corresponding to the producer applications into test data clustering models. The one or more algorithms may include a random forest algorithm (e.g., choosing optimum split points), an extra tree regressor algorithm (e.g., choosing randomly), a decision tree algorithm (e.g., where final predictions are obtained by accounting for predictions at every tree), a naïve bayes algorithm, other suitable algorithms, or a combination thereof. In some embodiments, the algorithm may include a random forest algorithm that builds multiple decision trees and merges the decision trees together to arrive at an accurate and stable prediction.

In some embodiments, the systems and methods described herein may be configured to receive a plurality of data records from one or more data producer applications. The systems and methods described herein may be configured to classify, using an artificial intelligence engine that uses a machine learning model configured to classify data records, data records of the plurality of data records into test data clustering models. In some embodiments, the machine learning model includes a supervised learning machine learning model. In some embodiments, the machine learning model includes an unsupervised learning machine learning model. In some embodiments, the machine learning model includes a k-means model. In some embodiments, the machine learning model includes a k-modes model.

The systems and methods described herein may be configured to receive input indicating one or more test case requirements. The systems and methods described herein may be configured to generate, based at least on the one or more test case requirements and the test data clustering models, at least one test case blueprint indicating at least one test data clustering model that corresponds to the one or more test case requirements. In some embodiments, the systems and methods described herein may be configured to use the artificial intelligence engine to use the machine learning model to identify a range of clustering models to be selected for data records of the plurality of data records based on a sum of squares function. In some embodiments, the systems and methods described herein may be configured to classify, using the artificial intelligence engine using the machine learning model, data records of the plurality of data records into test data clustering models based on the range of clustering models. In some embodiments, the systems and methods described herein may be configured to correlate the test data clustering models with existing test case scenarios.

In some embodiments, the systems and methods described herein may be configured to, in response to instructions to perform a data test corresponding to the test case requirements, use the at least one test case blueprint to populate test case data using data records corresponding to the at least one test data clustering model indicated by the at least one test case blueprint. In some embodiments, the systems and methods described herein may be configured to train the machine learning model using feedback corresponding to the performed data test. The systems and methods described herein may be configured to, in response to receiving subsequent data records from the one or more data producer applications, classify, using the artificial intelligence using the machine learning model, the subsequent data records into the test data clustering models.

In some embodiments, the systems and methods described herein may be configured to provide automated expected results predictions corresponding to one or more test cases (e.g., test scenarios). Typically, expected results prediction includes one or more techniques for predicting an outcome of test cases using machine learning models. Expected results predictions is typically well suited (e.g., but not restricted) for applications (e.g., such as those associated with a high volume pharmacy or other suitable enterprise or industry) that rely on numerical data.

Typically, using a machine learning model, predicting a numerical outcome may be classified as a regression problem. For example, for an input x and an output y, derived from a complex function of y=f(x), the machine learning model may be configured to predict the y attribute using regression algorithms.

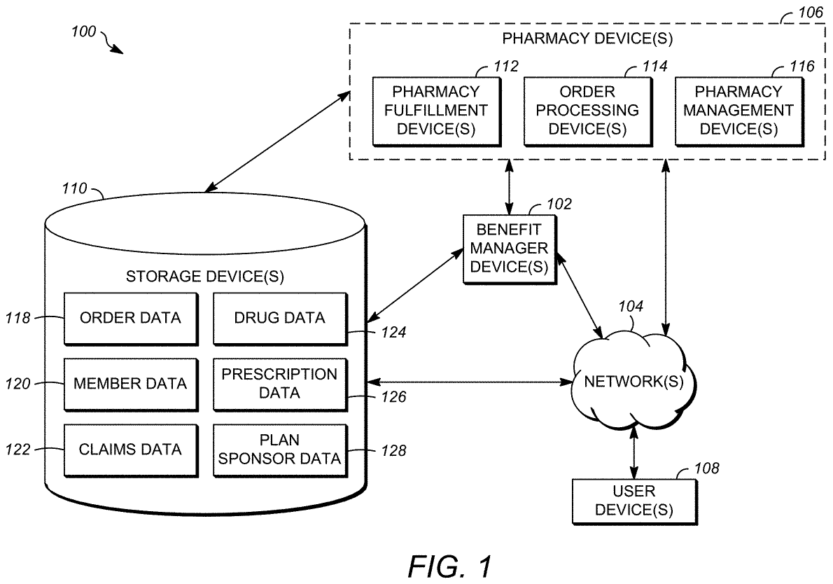

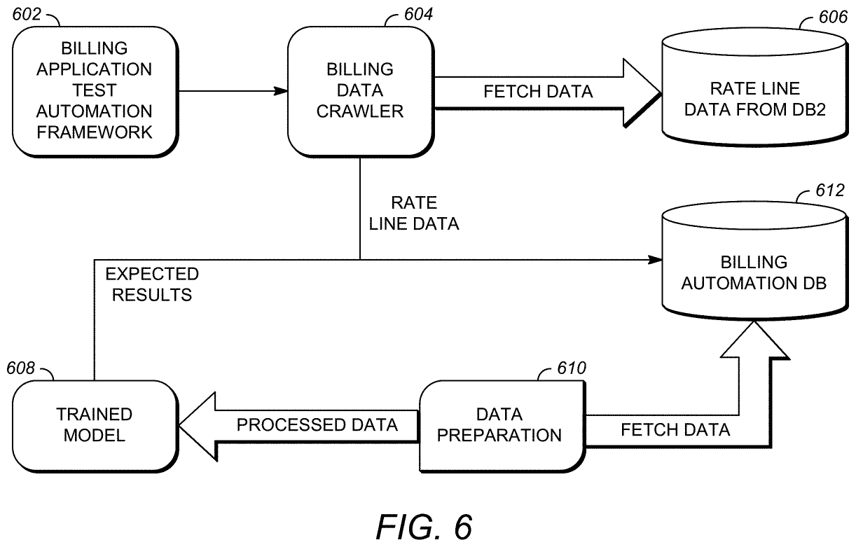

As described, the systems and methods described herein may be suitable for use in a high volume pharmacy, as will be described with respect to FIGS. 1-3. In FIG. 6, an example scenario for using the expected results prediction systems and methods described herein is generally illustrated. For example, a billing application 602 may generate invoices for a relatively large billing customer. Typically, rules for premium calculations account for many parameters, which may make automating a validation process difficult using traditional approaches. A machine learning model 608 (e.g., represented as “Trained Model”) use a billing data crawler 604 to crawl data processed in each test cycle of a test case, including fetching data from a rate line database 606 (e.g., represented as “Rate Line Data from DB2”) and may predict the premium amount based on various factors, such as a live count, a coverage period, an effective bill rate, an old live count, an old rate, a due paid category, a member account effective data, other suitable factors, or a combination thereof. The machine learning model 608 may retrieve actual premium amounts from a billing automation database 612. The machine learning model 608 may compare the predicted premium amounts with actual premium amounts using a test automation framework.

Typically, validating the numerical outcomes of transactional systems, such as the example described herein may be cumbersome based on the complexity of the scenarios. Building automated validations for such transactional systems may mimic repeating all business rules built into the application or system being tested. Techniques for providing expected results predictions typically involve comparing tables where the premium amounts are stored using various user interfaces to perform a tie off and/or the amounts are validated manually. Such techniques may not provide an effective approach as such techniques may generate many (e.g., several thousand) records for every test cycle of a corresponding test case. Validating such records may be difficult if not impossible without automation. Additionally, or alternatively, a typical automated techniques may not perform the premium calculations and such automated techniques may operate under the assumption that at least one of the data repositories used has the appropriate data (e.g., when often that is not the case).

Accordingly, systems and methods, such as those described herein, configured to provide automated expected results prediction using the appropriate date that has been automatically identified (e.g., as described), may be desirable. In some embodiments, the systems and methods described herein may be configured to use a linear regression to generate one or more expected results predictions. Additionally, or alternatively, the systems and methods described herein may be configured to use an extra tree regressor algorithm a greedy algorithm to select an optimal or substantially optimal split point. The systems and methods described herein may be configured to select a split point at random.

In some embodiments, the systems and methods described herein may be configured to, using the extra tree algorithm, build an ensemble of unpruned decision or regression trees. The systems and methods described herein may be configured to split nodes by selecting cut-points fully at random. The systems and methods described herein may be configured to use a entire learning sample to grow trees. The systems and methods described herein may be configured to use all available data in a training set to build each stump. The systems and methods described herein may be configured to, form the root node or any node, determine the best split by searching in a subset of randomly selected features of size square root (e.g., number of features). The systems and methods described herein may be configured to select splits of each selected feature at random (e.g., where the maximum depth of the decision stump is one). The systems and methods described herein may be configured to provide expected results predictions having a relatively high accuracy rate (e.g., at or near 99 percent) and a desirable mean absolute error value (e.g., at or near plus 6)

In some embodiments, the systems and methods described herein may be configured to receive a test case that uses data records from one or more applications. The data records may be classified using an unsupervised machine learning model or other suitable machine learning model.

The systems and methods described herein may be configured to predict, using an artificial intelligence engine that uses a machine learning model configured to predict test case outcomes, a test case outcome for each test cycle of the test case. The machine learning model may be trained using classified actual outcomes of test cases having similar test case requirements as the test case. In some embodiments, the machine learning model includes a supervised learning machine learning model. In some embodiments, the machine learning model uses a linear regression function. In some embodiments, the machine learning model uses a tree based algorithm. In some embodiments, the tree based algorithm includes an extra tree regressor based algorithm. In some embodiments, the tree based algorithm is tuned using at least one output metric. In some embodiments, the at least one output metric includes a mean absolute error metric. In some embodiments, the at least one output metric includes an accuracy metric.

The systems and methods described herein may be configured to compare, using a test automation framework, the predicted test case outcome for each test cycle of the test case to an actual outcome for each test cycle. The systems and methods described herein may be configured to generate a report indicating a result of the comparison of the predicted test case outcome for each test cycle of the test case to the actual outcome for each test cycle. In some embodiments, the systems and methods described herein may be configured to, using the report, further train the machine learning model.

In some embodiments, the systems and methods described herein may be applied to various enterprise organizations, such as a high volume pharmacy. FIG. 1 is a block diagram of an example implementation of a system 100 for a high-volume pharmacy. While the system 100 is generally described as being deployed in a high-volume pharmacy or a fulfillment center (for example, a mail order pharmacy, a direct delivery pharmacy, etc.), the system 100 and/or components of the system 100 may otherwise be deployed (for example, in a lower-volume pharmacy, or other enterprise organization related or unrelated to the pharmaceutical industry). A high-volume pharmacy may be a pharmacy that is capable of filling at least some prescriptions mechanically. The system 100 may include a benefit manager device 102 and a pharmacy device 106 in communication with each other directly and/or over a network 104. The system 100 may also include a storage device 110.

The benefit manager device 102 is a device operated by an entity that is at least partially responsible for creation and/or management of the pharmacy or drug benefit. While the entity operating the benefit manager device 102 is typically a pharmacy benefit manager (PBM), other entities may operate the benefit manager device 102 on behalf of themselves or other entities (such as PBMs). For example, the benefit manager device 102 may be operated by a health plan, a retail pharmacy chain, a drug wholesaler, a data analytics or other type of software-related company, etc. In some implementations, a PBM that provides the pharmacy benefit may provide one or more additional benefits including a medical or health benefit, a dental benefit, a vision benefit, a wellness benefit, a radiology benefit, a pet care benefit, an insurance benefit, a long term care benefit, a nursing home benefit, etc. The PBM may, in addition to its PBM operations, operate one or more pharmacies. The pharmacies may be retail pharmacies, mail order pharmacies, etc.

Some of the operations of the PBM that operates the benefit manager device 102 may include the following activities and processes. A member (or a person on behalf of the member) of a pharmacy benefit plan may obtain a prescription drug at a retail pharmacy location (e.g., a location of a physical store) from a pharmacist or a pharmacist technician. The member may also obtain the prescription drug through mail order drug delivery from a mail order pharmacy location, such as the system 100. In some implementations, the member may obtain the prescription drug directly or indirectly through the use of a machine, such as a kiosk, a vending unit, a mobile electronic device, or a different type of mechanical device, electrical device, electronic communication device, and/or computing device. Such a machine may be filled with the prescription drug in prescription packaging, which may include multiple prescription components, by the system 100. The pharmacy benefit plan is administered by or through the benefit manager device 102.

The member may have a copayment for the prescription drug that reflects an amount of money that the member is responsible to pay the pharmacy for the prescription drug. The money paid by the member to the pharmacy may come from, as examples, personal funds of the member, a health savings account (HSA) of the member or the member's family, a health reimbursement arrangement (HRA) of the member or the member's family, or a flexible spending account (FSA) of the member or the member's family. In some instances, an employer of the member may directly or indirectly fund or reimburse the member for the copayments.

The amount of the copayment required by the member may vary across different pharmacy benefit plans having different plan sponsors or clients and/or for different prescription drugs. The member's copayment may be a flat copayment (in one example, $10), coinsurance (in one example, 10%), and/or a deductible (for example, responsibility for the first $500 of annual prescription drug expense, etc.) for certain prescription drugs, certain types and/or classes of prescription drugs, and/or all prescription drugs. The copayment may be stored in the storage device 110 or determined by the benefit manager device 102.

In some instances, the member may not pay the copayment or may only pay a portion of the copayment for the prescription drug. For example, if a usual and customary cost for a generic version of a prescription drug is $4, and the member's flat copayment is $20 for the prescription drug, the member may only need to pay $4 to receive the prescription drug. In another example involving a worker's compensation claim, no copayment may be due by the member for the prescription drug.

In addition, copayments may also vary based on different delivery channels for the prescription drug. For example, the copayment for receiving the prescription drug from a mail order pharmacy location may be less than the copayment for receiving the prescription drug from a retail pharmacy location.

In conjunction with receiving a copayment (if any) from the member and dispensing the prescription drug to the member, the pharmacy submits a claim to the PBM for the prescription drug. After receiving the claim, the PBM (such as by using the benefit manager device 102) may perform certain adjudication operations including verifying eligibility for the member, identifying/reviewing an applicable formulary for the member to determine any appropriate copayment, coinsurance, and deductible for the prescription drug, and performing a drug utilization review (DUR) for the member. Further, the PBM may provide a response to the pharmacy (for example, the pharmacy system 100) following performance of at least some of the aforementioned operations.

As part of the adjudication, a plan sponsor (or the PBM on behalf of the plan sponsor) ultimately reimburses the pharmacy for filling the prescription drug when the prescription drug was successfully adjudicated. The aforementioned adjudication operations generally occur before the copayment is received and the prescription drug is dispensed. However in some instances, these operations may occur simultaneously, substantially simultaneously, or in a different order. In addition, more or fewer adjudication operations may be performed as at least part of the adjudication process.

The amount of reimbursement paid to the pharmacy by a plan sponsor and/or money paid by the member may be determined at least partially based on types of pharmacy networks in which the pharmacy is included. In some implementations, the amount may also be determined based on other factors. For example, if the member pays the pharmacy for the prescription drug without using the prescription or drug benefit provided by the PBM, the amount of money paid by the member may be higher than when the member uses the prescription or drug benefit. In some implementations, the amount of money received by the pharmacy for dispensing the prescription drug and for the prescription drug itself may be higher than when the member uses the prescription or drug benefit. Some or all of the foregoing operations may be performed by executing instructions stored in the benefit manager device 102 and/or an additional device.

Examples of the network 104 include a Global System for Mobile Communications (GSM) network, a code division multiple access (CDMA) network, 3rd Generation Partnership Project (3GPP), an Internet Protocol (IP) network, a Wireless Application Protocol (WAP) network, or an IEEE 802.11 standards network, as well as various combinations of the above networks. The network 104 may include an optical network. The network 104 may be a local area network or a global communication network, such as the Internet. In some implementations, the network 104 may include a network dedicated to prescription orders: a prescribing network such as the electronic prescribing network operated by Surescripts of Arlington, Va.

Moreover, although the system shows a single network 104, multiple networks can be used. The multiple networks may communicate in series and/or parallel with each other to link the devices 102-110.

The pharmacy device 106 may be a device associated with a retail pharmacy location (e.g., an exclusive pharmacy location, a grocery store with a retail pharmacy, or a general sales store with a retail pharmacy) or other type of pharmacy location at which a member attempts to obtain a prescription. The pharmacy may use the pharmacy device 106 to submit the claim to the PBM for adjudication.

Additionally, in some implementations, the pharmacy device 106 may enable information exchange between the pharmacy and the PBM. For example, this may allow the sharing of member information such as drug history that may allow the pharmacy to better service a member (for example, by providing more informed therapy consultation and drug interaction information). In some implementations, the benefit manager device 102 may track prescription drug fulfillment and/or other information for users that are not members, or have not identified themselves as members, at the time (or in conjunction with the time) in which they seek to have a prescription filled at a pharmacy.

The pharmacy device 106 may include a pharmacy fulfillment device 112, an order processing device 114, and a pharmacy management device 116 in communication with each other directly and/or over the network 104. The order processing device 114 may receive information regarding filling prescriptions and may direct an order component to one or more devices of the pharmacy fulfillment device 112 at a pharmacy. The pharmacy fulfillment device 112 may fulfill, dispense, aggregate, and/or pack the order components of the prescription drugs in accordance with one or more prescription orders directed by the order processing device 114.

In general, the order processing device 114 is a device located within or otherwise associated with the pharmacy to enable the pharmacy fulfilment device 112 to fulfill a prescription and dispense prescription drugs. In some implementations, the order processing device 114 may be an external order processing device separate from the pharmacy and in communication with other devices located within the pharmacy.

For example, the external order processing device may communicate with an internal pharmacy order processing device and/or other devices located within the system 100. In some implementations, the external order processing device may have limited functionality (e.g., as operated by a user requesting fulfillment of a prescription drug), while the internal pharmacy order processing device may have greater functionality (e.g., as operated by a pharmacist).

The order processing device 114 may track the prescription order as it is fulfilled by the pharmacy fulfillment device 112. The prescription order may include one or more prescription drugs to be filled by the pharmacy. The order processing device 114 may make pharmacy routing decisions and/or order consolidation decisions for the particular prescription order. The pharmacy routing decisions include what device(s) in the pharmacy are responsible for filling or otherwise handling certain portions of the prescription order. The order consolidation decisions include whether portions of one prescription order or multiple prescription orders should be shipped together for a user or a user family. The order processing device 114 may also track and/or schedule literature or paperwork associated with each prescription order or multiple prescription orders that are being shipped together. In some implementations, the order processing device 114 may operate in combination with the pharmacy management device 116.

The order processing device 114 may include circuitry, a processor, a memory to store data and instructions, and communication functionality. In some embodiments, the memory may include instructions that cause the processor of the order processing device 114 to, at least, perform the processes or methods described herein. The order processing device 114 is dedicated to performing processes, methods, and/or instructions described in this application. Other types of electronic devices may also be used that are specifically configured to implement the processes, methods, and/or instructions described in further detail below.

In some implementations, at least some functionality of the order processing device 114 may be included in the pharmacy management device 116. The order processing device 114 may be in a client-server relationship with the pharmacy management device 116, in a peer-to-peer relationship with the pharmacy management device 116, or in a different type of relationship with the pharmacy management device 116. The order processing device 114 and/or the pharmacy management device 116 may communicate directly (for example, such as by using a local storage) and/or through the network 104 (such as by using a cloud storage configuration, software as a service, etc.) with the storage device 110.

The storage device 110 may include: non-transitory storage (for example, memory, hard disk, CD-ROM, etc.) in communication with the benefit manager device 102 and/or the pharmacy device 106 directly and/or over the network 104. The non-transitory storage may store order data 118, member data 120, claims data 122, drug data 124, prescription data 126, and/or plan sponsor data 128. Further, the system 100 may include additional devices, which may communicate with each other directly or over the network 104.

The order data 118 may be related to a prescription order. The order data may include type of the prescription drug (for example, drug name and strength) and quantity of the prescription drug. The order data 118 may also include data used for completion of the prescription, such as prescription materials. In general, prescription materials include an electronic copy of information regarding the prescription drug for inclusion with or otherwise in conjunction with the fulfilled prescription. The prescription materials may include electronic information regarding drug interaction warnings, recommended usage, possible side effects, expiration date, date of prescribing, etc. The order data 118 may be used by a high-volume fulfillment center to fulfill a pharmacy order.

In some implementations, the order data 118 includes verification information associated with fulfillment of the prescription in the pharmacy. For example, the order data 118 may include videos and/or images taken of (i) the prescription drug prior to dispensing, during dispensing, and/or after dispensing, (ii) the prescription container (for example, a prescription container and sealing lid, prescription packaging, etc.) used to contain the prescription drug prior to dispensing, during dispensing, and/or after dispensing, (iii) the packaging and/or packaging materials used to ship or otherwise deliver the prescription drug prior to dispensing, during dispensing, and/or after dispensing, and/or (iv) the fulfillment process within the pharmacy. Other types of verification information such as barcode data read from pallets, bins, trays, or carts used to transport prescriptions within the pharmacy may also be stored as order data 118.

The member data 120 includes information regarding the members associated with the PBM. The information stored as member data 120 may include personal information, personal health information, protected health information, etc. Examples of the member data 120 include name, address, telephone number, e-mail address, prescription drug history, etc. The member data 120 may include a plan sponsor identifier that identifies the plan sponsor associated with the member and/or a member identifier that identifies the member to the plan sponsor. The member data 120 may include a member identifier that identifies the plan sponsor associated with the user and/or a user identifier that identifies the user to the plan sponsor. The member data 120 may also include dispensation preferences such as type of label, type of cap, message preferences, language preferences, etc.

The member data 120 may be accessed by various devices in the pharmacy (for example, the high-volume fulfillment center, etc.) to obtain information used for fulfillment and shipping of prescription orders. In some implementations, an external order processing device operated by or on behalf of a member may have access to at least a portion of the member data 120 for review, verification, or other purposes.

In some implementations, the member data 120 may include information for persons who are users of the pharmacy but are not members in the pharmacy benefit plan being provided by the PBM. For example, these users may obtain drugs directly from the pharmacy, through a private label service offered by the pharmacy, the high-volume fulfillment center, or otherwise. In general, the use of the terms “member” and “user” may be used interchangeably.

The claims data 122 includes information regarding pharmacy claims adjudicated by the PBM under a drug benefit program provided by the PBM for one or more plan sponsors. In general, the claims data 122 includes an identification of the client that sponsors the drug benefit program under which the claim is made, and/or the member that purchased the prescription drug giving rise to the claim, the prescription drug that was filled by the pharmacy (e.g., the national drug code number, etc.), the dispensing date, generic indicator, generic product identifier (GPI) number, medication class, the cost of the prescription drug provided under the drug benefit program, the copayment/coinsurance amount, rebate information, and/or member eligibility, etc. Additional information may be included.

In some implementations, other types of claims beyond prescription drug claims may be stored in the claims data 122. For example, medical claims, dental claims, wellness claims, or other types of health-care-related claims for members may be stored as a portion of the claims data 122.

In some implementations, the claims data 122 includes claims that identify the members with whom the claims are associated. Additionally or alternatively, the claims data 122 may include claims that have been de-identified (that is, associated with a unique identifier but not with a particular, identifiable member).

The drug data 124 may include drug name (e.g., technical name and/or common name), other names by which the drug is known, active ingredients, an image of the drug (such as in pill form), etc. The drug data 124 may include information associated with a single medication or multiple medications.

The prescription data 126 may include information regarding prescriptions that may be issued by prescribers on behalf of users, who may be members of the pharmacy benefit plan—for example, to be filled by a pharmacy. Examples of the prescription data 126 include user names, medication or treatment (such as lab tests), dosing information, etc. The prescriptions may include electronic prescriptions or paper prescriptions that have been scanned. In some implementations, the dosing information reflects a frequency of use (e.g., once a day, twice a day, before each meal, etc.) and a duration of use (e.g., a few days, a week, a few weeks, a month, etc.).

In some implementations, the order data 118 may be linked to associated member data 120, claims data 122, drug data 124, and/or prescription data 126.

The plan sponsor data 128 includes information regarding the plan sponsors of the PBM. Examples of the plan sponsor data 128 include company name, company address, contact name, contact telephone number, contact e-mail address, etc.

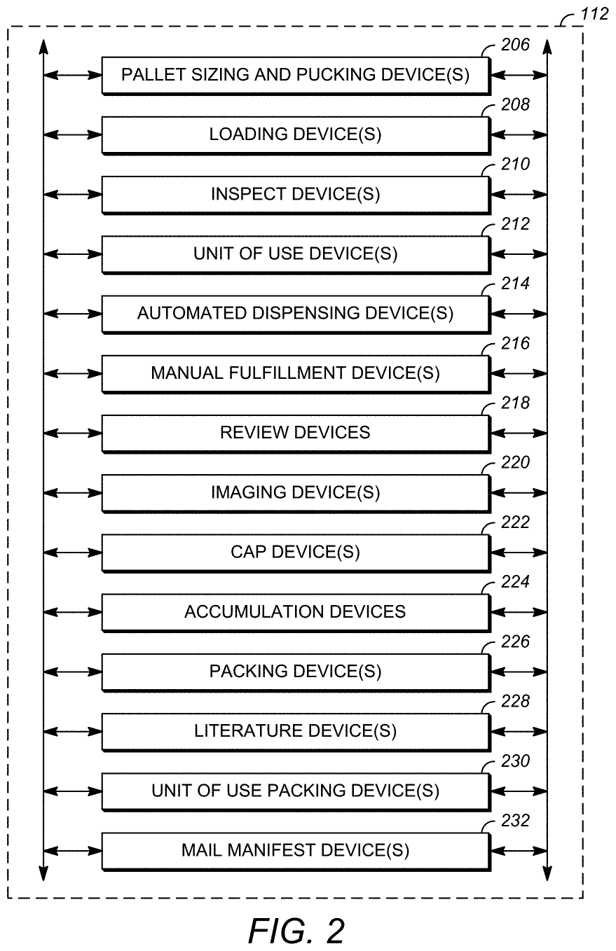

FIG. 2 illustrates the pharmacy fulfillment device 112 according to an example implementation. The pharmacy fulfillment device 112 may be used to process and fulfill prescriptions and prescription orders. After fulfillment, the fulfilled prescriptions are packed for shipping.

The pharmacy fulfillment device 112 may include devices in communication with the benefit manager device 102, the order processing device 114, and/or the storage device 110, directly or over the network 104. Specifically, the pharmacy fulfillment device 112 may include pallet sizing and pucking device(s) 206, loading device(s) 208, inspect device(s) 210, unit of use device(s) 212, automated dispensing device(s) 214, manual fulfillment device(s) 216, review devices 218, imaging device(s) 220, cap device(s) 222, accumulation devices 224, packing device(s) 226, literature device(s) 228, unit of use packing device(s) 230, and mail manifest device(s) 232. Further, the pharmacy fulfillment device 112 may include additional devices, which may communicate with each other directly or over the network 104.

In some implementations, operations performed by one of these devices 206-232 may be performed sequentially, or in parallel with the operations of another device as may be coordinated by the order processing device 114. In some implementations, the order processing device 114 tracks a prescription with the pharmacy based on operations performed by one or more of the devices 206-232.

In some implementations, the pharmacy fulfillment device 112 may transport prescription drug containers, for example, among the devices 206-232 in the high-volume fulfillment center, by use of pallets. The pallet sizing and pucking device 206 may configure pucks in a pallet. A pallet may be a transport structure for a number of prescription containers, and may include a number of cavities. A puck may be placed in one or more than one of the cavities in a pallet by the pallet sizing and pucking device 206. The puck may include a receptacle sized and shaped to receive a prescription container. Such containers may be supported by the pucks during carriage in the pallet. Different pucks may have differently sized and shaped receptacles to accommodate containers of differing sizes, as may be appropriate for different prescriptions.

The arrangement of pucks in a pallet may be determined by the order processing device 114 based on prescriptions that the order processing device 114 decides to launch. The arrangement logic may be implemented directly in the pallet sizing and pucking device 206. Once a prescription is set to be launched, a puck suitable for the appropriate size of container for that prescription may be positioned in a pallet by a robotic arm or pickers. The pallet sizing and pucking device 206 may launch a pallet once pucks have been configured in the pallet.

The loading device 208 may load prescription containers into the pucks on a pallet by a robotic arm, a pick and place mechanism (also referred to as pickers), etc. In various implementations, the loading device 208 has robotic arms or pickers to grasp a prescription container and move it to and from a pallet or a puck. The loading device 208 may also print a label that is appropriate for a container that is to be loaded onto the pallet, and apply the label to the container. The pallet may be located on a conveyor assembly during these operations (e.g., at the high-volume fulfillment center, etc.).

The inspect device 210 may verify that containers in a pallet are correctly labeled and in the correct spot on the pallet. The inspect device 210 may scan the label on one or more containers on the pallet. Labels of containers may be scanned or imaged in full or in part by the inspect device 210. Such imaging may occur after the container has been lifted out of its puck by a robotic arm, picker, etc., or may be otherwise scanned or imaged while retained in the puck. In some implementations, images and/or video captured by the inspect device 210 may be stored in the storage device 110 as order data 118.

The unit of use device 212 may temporarily store, monitor, label, and/or dispense unit of use products. In general, unit of use products are prescription drug products that may be delivered to a user or member without being repackaged at the pharmacy. These products may include pills in a container, pills in a blister pack, inhalers, etc. Prescription drug products dispensed by the unit of use device 212 may be packaged individually or collectively for shipping, or may be shipped in combination with other prescription drugs dispensed by other devices in the high-volume fulfillment center.

At least some of the operations of the devices 206-232 may be directed by the order processing device 114. For example, the manual fulfillment device 216, the review device 218, the automated dispensing device 214, and/or the packing device 226, etc. may receive instructions provided by the order processing device 114.

The automated dispensing device 214 may include one or more devices that dispense prescription drugs or pharmaceuticals into prescription containers in accordance with one or multiple prescription orders. In general, the automated dispensing device 214 may include mechanical and electronic components with, in some implementations, software and/or logic to facilitate pharmaceutical dispensing that would otherwise be performed in a manual fashion by a pharmacist and/or pharmacist technician. For example, the automated dispensing device 214 may include high-volume fillers that fill a number of prescription drug types at a rapid rate and blister pack machines that dispense and pack drugs into a blister pack. Prescription drugs dispensed by the automated dispensing devices 214 may be packaged individually or collectively for shipping, or may be shipped in combination with other prescription drugs dispensed by other devices in the high-volume fulfillment center.

The manual fulfillment device 216 controls how prescriptions are manually fulfilled. For example, the manual fulfillment device 216 may receive or obtain a container and enable fulfillment of the container by a pharmacist or pharmacy technician. In some implementations, the manual fulfillment device 216 provides the filled container to another device in the pharmacy fulfillment devices 112 to be joined with other containers in a prescription order for a user or member.

In general, manual fulfillment may include operations at least partially performed by a pharmacist or a pharmacy technician. For example, a person may retrieve a supply of the prescribed drug, may make an observation, may count out a prescribed quantity of drugs and place them into a prescription container, etc. Some portions of the manual fulfillment process may be automated by use of a machine. For example, counting of capsules, tablets, or pills may be at least partially automated (such as through use of a pill counter). Prescription drugs dispensed by the manual fulfillment device 216 may be packaged individually or collectively for shipping, or may be shipped in combination with other prescription drugs dispensed by other devices in the high-volume fulfillment center.

The review device 218 may process prescription containers to be reviewed by a pharmacist for proper pill count, exception handling, prescription verification, etc. Fulfilled prescriptions may be manually reviewed and/or verified by a pharmacist, as may be required by state or local law. A pharmacist or other licensed pharmacy person who may dispense certain drugs in compliance with local and/or other laws may operate the review device 218 and visually inspect a prescription container that has been filled with a prescription drug. The pharmacist may review, verify, and/or evaluate drug quantity, drug strength, and/or drug interaction concerns, or otherwise perform pharmacist services. The pharmacist may also handle containers which have been flagged as an exception, such as containers with unreadable labels, containers for which the associated prescription order has been canceled, containers with defects, etc. In an example, the manual review can be performed at a manual review station.

The imaging device 220 may image containers once they have been filled with pharmaceuticals. The imaging device 220 may measure a fill height of the pharmaceuticals in the container based on the obtained image to determine if the container is filled to the correct height given the type of pharmaceutical and the number of pills in the prescription. Images of the pills in the container may also be obtained to detect the size of the pills themselves and markings thereon. The images may be transmitted to the order processing device 114 and/or stored in the storage device 110 as part of the order data 118.

The cap device 222 may be used to cap or otherwise seal a prescription container. In some implementations, the cap device 222 may secure a prescription container with a type of cap in accordance with a user preference (e.g., a preference regarding child resistance, etc.), a plan sponsor preference, a prescriber preference, etc. The cap device 222 may also etch a message into the cap, although this process may be performed by a subsequent device in the high-volume fulfillment center.

The accumulation device 224 accumulates various containers of prescription drugs in a prescription order. The accumulation device 224 may accumulate prescription containers from various devices or areas of the pharmacy. For example, the accumulation device 224 may accumulate prescription containers from the unit of use device 212, the automated dispensing device 214, the manual fulfillment device 216, and the review device 218. The accumulation device 224 may be used to group the prescription containers prior to shipment to the member.

The literature device 228 prints, or otherwise generates, literature to include with each prescription drug order. The literature may be printed on multiple sheets of substrates, such as paper, coated paper, printable polymers, or combinations of the above substrates. The literature printed by the literature device 228 may include information required to accompany the prescription drugs included in a prescription order, other information related to prescription drugs in the order, financial information associated with the order (for example, an invoice or an account statement), etc.

In some implementations, the literature device 228 folds or otherwise prepares the literature for inclusion with a prescription drug order (e.g., in a shipping container). In other implementations, the literature device 228 prints the literature and is separate from another device that prepares the printed literature for inclusion with a prescription order.

The packing device 226 packages the prescription order in preparation for shipping the order. The packing device 226 may box, bag, or otherwise package the fulfilled prescription order for delivery. The packing device 226 may further place inserts (e.g., literature or other papers, etc.) into the packaging received from the literature device 228. For example, bulk prescription orders may be shipped in a box, while other prescription orders may be shipped in a bag, which may be a wrap seal bag.

The packing device 226 may label the box or bag with an address and a recipient's name. The label may be printed and affixed to the bag or box, be printed directly onto the bag or box, or otherwise associated with the bag or box. The packing device 226 may sort the box or bag for mailing in an efficient manner (e.g., sort by delivery address, etc.). The packing device 226 may include ice or temperature sensitive elements for prescriptions that are to be kept within a temperature range during shipping (for example, this may be necessary in order to retain efficacy). The ultimate package may then be shipped through postal mail, through a mail order delivery service that ships via ground and/or air (e.g., UPS, FEDEX, or DHL, etc.), through a delivery service, through a locker box at a shipping site (e.g., AMAZON locker or a PO Box, etc.), or otherwise.

The unit of use packing device 230 packages a unit of use prescription order in preparation for shipping the order. The unit of use packing device 230 may include manual scanning of containers to be bagged for shipping to verify each container in the order. In an example implementation, the manual scanning may be performed at a manual scanning station. The pharmacy fulfillment device 112 may also include a mail manifest device 232 to print mailing labels used by the packing device 226 and may print shipping manifests and packing lists.

While the pharmacy fulfillment device 112 in FIG. 2 is shown to include single devices 206-232, multiple devices may be used. When multiple devices are present, the multiple devices may be of the same device type or models, or may be a different device type or model. The types of devices 206-232 shown in FIG. 2 are example devices. In other configurations of the system 100, lesser, additional, or different types of devices may be included.

Moreover, multiple devices may share processing and/or memory resources. The devices 206-232 may be located in the same area or in different locations. For example, the devices 206-232 may be located in a building or set of adjoining buildings. The devices 206-232 may be interconnected (such as by conveyors), networked, and/or otherwise in contact with one another or integrated with one another (e.g., at the high-volume fulfillment center, etc.). In addition, the functionality of a device may be split among a number of discrete devices and/or combined with other devices.

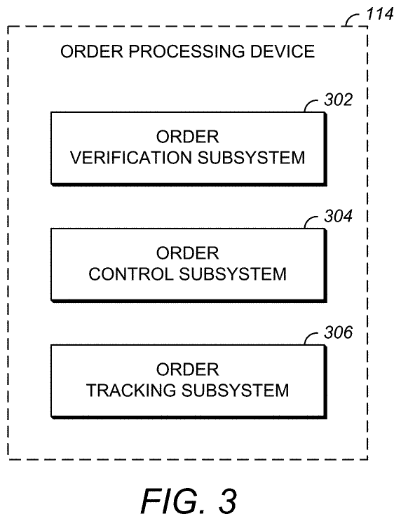

FIG. 3 illustrates the order processing device 114 according to an example implementation. The order processing device 114 may be used by one or more operators to generate prescription orders, make routing decisions, make prescription order consolidation decisions, track literature with the system 100, and/or view order status and other order related information. For example, the prescription order may be comprised of order components.

The order processing device 114 may receive instructions to fulfill an order without operator intervention. An order component may include a prescription drug fulfilled by use of a container through the system 100. The order processing device 114 may include an order verification subsystem 302, an order control subsystem 304, and/or an order tracking subsystem 306. Other subsystems may also be included in the order processing device 114.

The order verification subsystem 302 may communicate with the benefit manager device 102 to verify the eligibility of the member and review the formulary to determine appropriate copayment, coinsurance, and deductible for the prescription drug and/or perform a DUR (drug utilization review). Other communications between the order verification subsystem 302 and the benefit manager device 102 may be performed for a variety of purposes.

The order control subsystem 304 controls various movements of the containers and/or pallets along with various filling functions during their progression through the system 100. In some implementations, the order control subsystem 304 may identify the prescribed drug in one or more than one prescription orders as capable of being fulfilled by the automated dispensing device 214. The order control subsystem 304 may determine which prescriptions are to be launched and may determine that a pallet of automated-fill containers is to be launched.

The order control subsystem 304 may determine that an automated-fill prescription of a specific pharmaceutical is to be launched and may examine a queue of orders awaiting fulfillment for other prescription orders, which will be filled with the same pharmaceutical. The order control subsystem 304 may then launch orders with similar automated-fill pharmaceutical needs together in a pallet to the automated dispensing device 214. As the devices 206-232 may be interconnected by a system of conveyors or other container movement systems, the order control subsystem 304 may control various conveyors: for example, to deliver the pallet from the loading device 208 to the manual fulfillment device 216 from the literature device 228, paperwork as needed to fill the prescription.

The order tracking subsystem 306 may track a prescription order during its progress toward fulfillment. The order tracking subsystem 306 may track, record, and/or update order history, order status, etc. The order tracking subsystem 306 may store data locally (for example, in a memory) or as a portion of the order data 118 stored in the storage device 110.

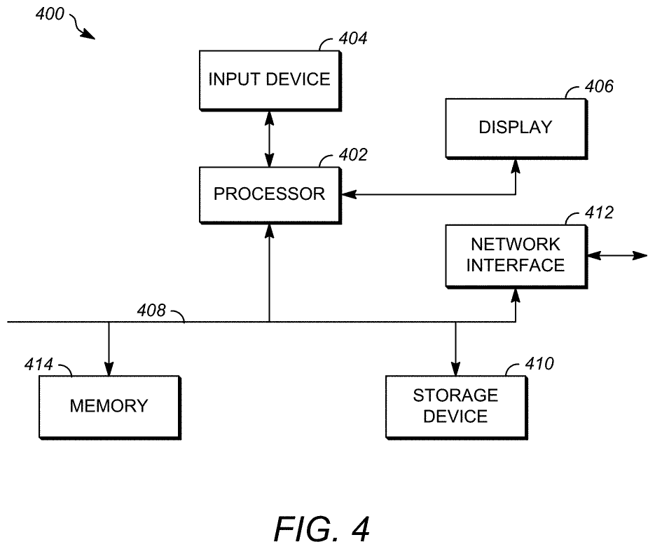

In some embodiments, the order processing device 114 may include or be in communication with a computing device, such as a computing device 400 generally illustrated in FIG. 4. The computing device 400 may be configured to interact with the order processing device 114 and/or any other devices or mechanisms of the system 100. In some embodiments, the computing device 100 may be configured to perform automated test data preparation and/or generate expected results predictions, as described herein. The computing device 400 may be any suitable computing device, such as a mobile computing device, a laptop computing device, a desktop computing device, a server-computing device, or any other suitable computing device.

The computing device 400 may include a processor 402 configured to control the overall operation of computing device 400. The processor 402 may include any suitable processor, such as those described herein. Additionally, or alternatively, the computing device 400 may include one or more processors including and/or in addition to the processor 102. The computing device 400 may also include a user input device 404 that is configured to receive input from a user of the computing device 400 and to communicate signals representing the input received from the user to the processor 402. For example, the user input device 404 may include a button, keypad, dial, touch screen, audio input interface, visual/image capture input interface, input in the form of sensor data, and the like.

The computing device 400 may include a display 406 that may be controlled by the processor 402 to display information to the user. A data bus 408 may be configured to facilitate data transfer between, at least, a storage device 410 and the processor 402. The computing device 400 may also include a network interface 412 configured to couple or connect the computing device 400 to various other computing devices or network devices via a network connection, such as a wired or wireless connection. In some embodiments, the network interface 12 includes a wireless transceiver.

The storage device 410 may comprise a single disk or a plurality of disks (e.g., hard drives), one or more solid-state drives, one or more hybrid hard drives, and the like. The storage device 410 may includes a storage management module that manages one or more partitions within the storage device 410. In some embodiments, storage device 410 may flash memory, semiconductor (solid state) memory or the like. The computing device 400 may also include a memory 414. The memory 414 may include Random Access Memory (RAM), a Read-Only Memory (ROM), or a combination thereof. The memory 414 may store programs, utilities, or processes to be executed in by the processor 402. The memory 414 may provide volatile data storage, and stores instructions related to the operation of the computing device 400.

In some embodiments, the memory 414 may include instructions that, when executed by the processor 402, case the processor 402 to perform various techniques, such as those described herein. In some embodiments, the computing device 400 may include, user, or communicate with an artificial intelligence engine. The artificial intelligence engine may be integrated with the computing device 400 or remotely located (e.g., on a server computing device or other suitable computing device) from the computing device 400. The artificial intelligence engine may use one or more machine learning models to perform at least one of the embodiments disclosed herein. The computing device 400 may include a training engine capable of generating the one or more machine learning models. The machine learning models may be trained using various data, such as the data records, test results data, expected results prediction data, or any other suitable data. The one or more machine learning models may be generated by the training engine and may be implemented in computer instructions executable by the processor 402. To generate the one or more machine learning models, the training engine may train the one or more machine learning models using feedback provided by a user (e.g., of the computing device 400) or generated by the computing device 400.

In some embodiments, the computing device 400 may be configured to provide test data preparation features, such as those described herein. For example, the computing device 400 may receive a plurality of data records from one or more data producer applications, such as those described herein related to the high volume pharmacy or other suitable producer applications. The computing device 400 may classify, using the artificial intelligence engine using at least one machine learning model configured to classify data records, data records of the plurality of data records into test data clustering models. The machine learning model may include any suitable machine learning model, such as a supervised learning machine learning model, an unsupervised learning machine learning model, or other suitable machine learning model. Additionally, or alternatively, the machine learning model may include a k-means model, a k-modes model, or other suitable machine learning model.

The computing device 400 may receive input indicating one or more test case requirements. The test case requirements may correspond to a test case associated with the high volume pharmacy or other suitable enterprise. The input may include an input field disposed on a user interface. The computing device 400 may display, using the display 106, the user interface. The user of the computing device 400 may provide the input by entering information, such as text or other suitable information, into the input field on the user interface. The computing device 400 may generate, based at least on the one or more test case requirements and the test data clustering models, at least one test case blueprint indicating at least one test data clustering model that corresponds to the one or more test case requirements.

In some embodiments, the computing device 400 may use the artificial intelligence engine to use the machine learning model to identify a range of clustering models to be selected for data records of the plurality of data records based on a sum of squares function. The computing device 400 may classify, using the artificial intelligence engine using the machine learning model, data records of the plurality of data records into test data clustering models based on the range of clustering models. The computing device 400 may correlate the test data clustering models with existing test case scenarios.

In some embodiments, The computing device 400 may, in response to instructions to perform a data test corresponding to the test case requirements, use the at least one test case blueprint to populate test case data using data records corresponding to the at least one test data clustering model indicated by the at least one test case blueprint.

In some embodiments, the computing device 400 may train the machine learning model using feedback corresponding to the performed data test. The computing device 400 may, in response to receiving subsequent data records from the one or more data producer applications, classify, using the artificial intelligence using the machine learning model, the subsequent data records into the test data clustering models.

In some embodiments, the computing device 400 may be configured to provide expected results predictions. For example, the computing device 400 may receive a test case that uses data records from one or more applications, such as those described herein. The data records may be classified using an unsupervised machine learning model or other suitable machine learning model.

The computing device 400 may predict, using the artificial intelligence engine using at least one machine learning model configured to predict test case outcomes, a test case outcome for each test cycle of the test case. The computing device 40 may train the machine learning model using classified actual outcomes of test cases having similar test case requirements as the test case. The machine learning model may include any suitable machine learning model such as a supervised learning machine learning model or other suitable machine learning model. In some embodiments, the machine learning model may use a linear regression function.

In some embodiments, the machine learning model may use a tree based algorithm, such as an extra tree regressor based algorithm, other suitable algorithm, or a combination thereof. The computing device 400 may tune the tree based algorithm using at least one output metric. The at least one output metric may include s a mean absolute error metric, an accuracy metric, other suitable metric, or a combination thereof.

The computing device 400 may compare, using a test automation framework, the predicted test case outcome for each test cycle of the test case to an actual outcome for each test cycle. The computing device 400 may generate a report indicating a result of the comparison of the predicted test case outcome for each test cycle of the test case to the actual outcome for each test cycle. The computing device 400 may display, using the display 406, the report. In some embodiments, the computing device 400 may, using the report, further train the machine learning model.

In some embodiments, the computing device 400 may perform the methods described herein. However, the methods described herein as performed by the computing device 400 a are not meant to be limiting, and any type of software executed on a computing device or a combination of various computing devices can perform the methods described herein without departing from the scope of this disclosure.

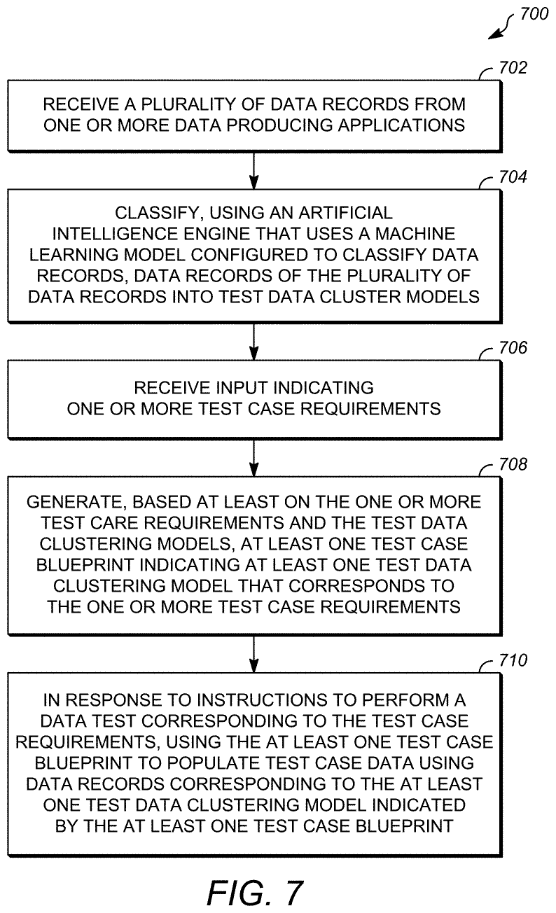

FIG. 7 is a flow diagram generally illustrating a test data preparation method 700 according to the principles of the present disclosure. At 702, the method 700 receives a plurality of data records from one or more data producer applications. For example, the computing device 400 may receive the plurality of data records from the one or more producer applications.

At 704, the method 700 classifies, using an artificial intelligence engine that uses a machine learning model configured to classify data records, data records of the plurality of data records into test data clustering model. For example, the computing device 400 may classify the data records of the plurality of data records into test data clustering models using the artificial intelligence using the machine learning model configured to classify data records.

At 706, the method 700 receives input indicating one or more test case requirements. For example, the computing device 400 may receive the input indicating the one or more test case requirements.

At 708, the method 700 generates, based at least on the one or more test case requirements and the test data clustering models, at least one test case blueprint indicating at least one test data clustering model that corresponds to the one or more test case requirements. For example, the computing device 400 may generate at least one test case blueprint based at least on the one or more test case requirements and the test data clustering models. The blueprint may indicate at least one test data clustering model corresponding to the one or more test case requirements.

At 710, the method 700, in response to instructions to perform a data test corresponding to the test case requirements, uses the at least one test case blueprint to populate test case data using data records corresponding to the at least one test data clustering model indicated by the at least one test case blueprint. For example, the computing device 400 may use the at least one test case blueprint to populate the test case data using the data records corresponding to the at least one test data clustering model indicated by the at least one test case blueprint, in response to instructions to perform the data test corresponding to the test case requirements.

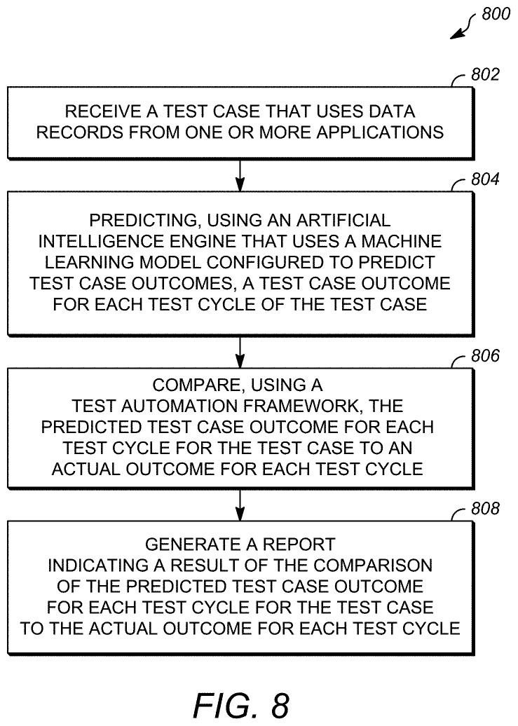

FIG. 8 is a flow diagram generally illustrating an expected results prediction method 800 according to the principles of the present disclosure. At 802, the method 800 receives a test case that uses data records from one or more applications. For example, the computing device 400 may receive the test case. The test case may use the data records generated by the one or more producer applications or other suitable applications.

At 804, the method 800 may predate, using an artificial intelligence engine that uses a machine learning model configured to predict test case outcomes, a test case outcome for each test cycle of the test case. For example, the computing device 400 may predict, using the artificial intelligence engine using the machine learning mode configured to predict test case outcomes, the test case outcome for each test cycle of the test case. The machine learning model may be trained using the classified actual outcomes of test cases having similar test case requirements as the test case.

At 806, the method 800 compares, using a test automation framework, the predicted test case outcome for each test cycle of the test case to an actual outcome for each test cycle. For example, the computing device 400 may compare the predicted test case outcome for each test cycle of the test case to the actual outcome for each test cycle, using the test automation framework.

At 808, the method 800 generates a report indicating a result of the comparison of the predicted test case outcome for each test cycle of the test case to the actual outcome for each test cycle. For example, the computing device 400 may generate the report. The report may indicate the result of the comparison of the predicted test case outcome for each test cycle of the test case to the actual outcome for each test cycle.

In some embodiments, a system for automatically identifying test case data includes a processor and a memory. The memory includes instructions that, when executed by the processor, cause the processor to: receive a plurality of data records from one or more data producer applications; classify, using an artificial intelligence engine that uses a machine learning model configured to classify data records, data records of the plurality of data records into test data clustering models; receive input indicating one or more test case requirements; generate, based at least on the one or more test case requirements and the test data clustering models, at least one test case blueprint indicating at least one test data clustering model that corresponds to the one or more test case requirements; and, in response to instructions to perform a data test corresponding to the test case requirements, use the at least one test case blueprint to populate test case data using data records corresponding to the at least one test data clustering model indicated by the at least one test case blueprint.

In some embodiments, the machine learning model includes a supervised learning machine learning model. In some embodiments, the machine learning model includes an unsupervised learning machine learning model. In some embodiments, the machine learning model includes a k-means model. In some embodiments, the machine learning model includes a k-modes model. In some embodiments, the instructions further cause the processor to use the artificial intelligence engine to use the machine learning model to identify a range of clustering models to be selected for data records of the plurality of data records based on a sum of squares function. In some embodiments, the instructions further cause the processor to classify, using the artificial intelligence engine using the machine learning model, data records of the plurality of data records into test data clustering models based on the range of clustering models. In some embodiments, the test data clustering models are correlated with existing test case scenarios.

In some embodiments, a method for automatically identifying test case data includes receiving a plurality of data records from one or more data producer applications and classifying, using an artificial intelligence engine that uses a machine learning model configured to classify data records, data records of the plurality of data records into test data clustering model. The method also includes receiving input indicating one or more test case requirements and generating, based at least on the one or more test case requirements and the test data clustering models, at least one test case blueprint indicating at least one test data clustering model that corresponds to the one or more test case requirements. The method also includes, in response to instructions to perform a data test corresponding to the test case requirements, using the at least one test case blueprint to populate test case data using data records corresponding to the at least one test data clustering model indicated by the at least one test case blueprint.

In some embodiments, the machine learning model includes a supervised learning machine learning model. In some embodiments, the machine learning model includes an unsupervised learning machine learning model. In some embodiments, the machine learning model includes a k-means model. In some embodiments, the machine learning model includes a k-modes model. In some embodiments, the method also includes using the artificial intelligence engine to use the machine learning model to identify a range of clustering models to be selected for data records of the plurality of data records based on a sum of squares function. In some embodiments, the method further includes classifying, using the artificial intelligence engine using the machine learning model, data records of the plurality of data records into test data clustering models based on the range of clustering models. In some embodiments, the test data clustering models are correlated with existing test case scenarios.

In some embodiments, an apparatus for automatically identifying test case data includes a processor and a memory. The memory includes instructions that, when executed by the processor, cause the processor to: receive a plurality of data records from one or more data producer applications; classify, using an artificial intelligence engine that uses a machine learning model configured to classify data records, data records of the plurality of data records into test data clustering models; receive input indicating one or more test case requirements; generate, based at least on the one or more test case requirements and the test data clustering models, at least one test case blueprint indicating at least one test data clustering model that corresponds to the one or more test case requirements; in response to instructions to perform a data test corresponding to the test case requirements, use the at least one test case blueprint to populate test case data using data records corresponding to the at least one test data clustering model indicated by the at least one test case blueprint; train the machine learning model using feedback corresponding to the performed data test; and, in response to receiving subsequent data records from the one or more data producer applications, classify, using the artificial intelligence using the machine learning model, the subsequent data records into the test data clustering models.

In some embodiments, the machine learning model includes an unsupervised learning machine learning model. In some embodiments, the machine learning model includes a k-means model. In some embodiments, the machine learning model includes a k-modes model.

In some embodiments, a system for predicting expected results of at least one test case includes a processor and a memory. The memory includes instructions that, when executed by the processor, cause the processor to: receive a test case that uses data records from one or more applications; predict, using an artificial intelligence engine that uses a machine learning model configured to predict test case outcomes, a test case outcome for each test cycle of the test case, the machine learning model being trained using classified actual outcomes of test cases having similar test case requirements as the test case; compare, using a test automation framework, the predicted test case outcome for each test cycle of the test case to an actual outcome for each test cycle; and generate a report indicating a result of the comparison of the predicted test case outcome for each test cycle of the test case to the actual outcome for each test cycle.

In some embodiments, the machine learning model includes a supervised learning machine learning model. In some embodiments, the machine learning model uses a linear regression function. In some embodiments, the instructions further cause the processor to, using the report, further train the machine learning model. In some embodiments, the machine learning model uses a tree based algorithm. In some embodiments, the tree based algorithm includes an extra tree regressor based algorithm. In some embodiments, the tree based algorithm is tuned using at least one output metric. In some embodiments, the at least one output metric includes a mean absolute error metric. In some embodiments, the at least one output metric includes an accuracy metric.

In some embodiments, a method for predicting expected results of at least one test case includes receiving a test case that uses data records from one or more applications and predicting, using an artificial intelligence engine that uses a machine learning model configured to predict test case outcomes, a test case outcome for each test cycle of the test case, the machine learning model being trained using classified actual outcomes of test cases having similar test case requirements as the test case. The method also includes comparing, using a test automation framework, the predicted test case outcome for each test cycle of the test case to an actual outcome for each test cycle and generating a report indicating a result of the comparison of the predicted test case outcome for each test cycle of the test case to the actual outcome for each test cycle.

In some embodiments, the machine learning model includes a supervised learning machine learning model. In some embodiments, the machine learning model uses a linear regression function. In some embodiments, the method also includes, using the report, further training the machine learning model. In some embodiments, the machine learning model uses a tree based algorithm. In some embodiments, the tree based algorithm includes an extra tree regressor based algorithm. In some embodiments, the tree based algorithm is tuned using at least one output metric. In some embodiments, the at least one output metric includes a mean absolute error metric. In some embodiments, the at least one output metric includes an accuracy metric.

In some embodiments, an apparatus for predicting expected results of at least one test case includes a processor and a memory. The memory includes instructions that, when executed by the processor, cause the processor to: receive a test case that uses data records from one or more applications, the data records being classified using an unsupervised machine learning model; predict, using an artificial intelligence engine that uses a supervised machine learning model configured to predict test case outcomes, a test case outcome for each test cycle of the test case, the supervised machine learning model being trained using classified actual outcomes of test cases having similar test case requirements as the test case; compare, using a test automation framework, the predicted test case outcome for each test cycle of the test case to an actual outcome for each test cycle; generate a report indicating a result of the comparison of the predicted test case outcome for each test cycle of the test case to the actual outcome for each test cycle; and using the report, further train the supervised machine learning model.

In some embodiments, the supervised machine learning model uses a tree based algorithm.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A. The term subset does not necessarily require a proper subset. In other words, a first subset of a first set may be coextensive with (equal to) the first set.

In this application, including the definitions below, the term “module” or the term “controller” may be replaced with the term “circuit.” The term “module” may refer to, be part of, or include processor hardware (shared, dedicated, or group) that executes code and memory hardware (shared, dedicated, or group) that stores code executed by the processor hardware.

The module may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2016 (also known as the WIFI wireless networking standard) and IEEE Standard 802.3-2015 (also known as the ETHERNET wired networking standard). Examples of a WPAN are the BLUETOOTH wireless networking standard from the Bluetooth Special Interest Group and IEEE Standard 802.15.4.

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module may be distributed among multiple modules that are connected via the communications system. For example, multiple modules may implement the same functionality distributed by a load balancing system. In a further example, the functionality of the module may be split between a server (also known as remote, or cloud) module and a client (or, user) module.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

Implementations of the systems, algorithms, methods, instructions, etc., described herein may be realized in hardware, software, or any combination thereof. The hardware may include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably.

What is claimed is:

1. A system for automatically identifying test case data, the system comprising:
a processor; and
a memory including instructions that, when executed by the processor, cause the processor to:
receive a plurality of data records from one or more data producer applications;
classify, using an artificial intelligence engine that uses a machine learning model configured to classify data records, data records of the plurality of data records into test data clustering models;
receive input indicating one or more test case requirements;
generate, based at least on the one or more test case requirements and the test data clustering models, at least one test case blueprint indicating at least one test data clustering model that corresponds to the one or more test case requirements; and
in response to instructions to perform a data test corresponding to the test case requirements, use the at least one test case blueprint to populate test case data using data records corresponding to the at least one test data clustering model indicated by the at least one test case blueprint.

2. The system of claim 1, wherein the machine learning model includes a supervised learning machine learning model.

3. The system of claim 1, wherein the machine learning model includes an unsupervised learning machine learning model.

4. The system of claim 3, wherein the machine learning model includes a k-means model.

5. The system of claim 3, wherein the machine learning model includes a k-modes model.

6. The system of claim 5, wherein the instructions further cause the processor to use the artificial intelligence engine to use the machine learning model to identify a range of clustering models to be selected for data records of the plurality of data records based on a sum of squares function.

7. The system of claim 6, wherein the instructions further cause the processor to classify, using the artificial intelligence engine using the machine learning model, data records of the plurality of data records into test data clustering models based on the range of clustering models.

8. The system of claim 1, wherein the test data clustering models are correlated with existing test case scenarios.

9. A method for automatically identifying test case data, the method comprising:
receiving a plurality of data records from one or more data producer applications;
classifying, using an artificial intelligence engine that uses a machine learning model configured to classify data records, data records of the plurality of data records into test data clustering models;
receiving input indicating one or more test case requirements;
generating, based at least on the one or more test case requirements and the test data clustering models, at least one test case blueprint indicating at least one test data clustering model that corresponds to the one or more test case requirements; and
in response to instructions to perform a data test corresponding to the test case requirements, using the at least one test case blueprint to populate test case data using data records corresponding to the at least one test data clustering model indicated by the at least one test case blueprint.

10. The method of claim 9, wherein the machine learning model includes a supervised learning machine learning model.

11. The method of claim 9, wherein the machine learning model includes an unsupervised learning machine learning model.

12. The method of claim 11, wherein the machine learning model includes a k-means model.

13. The method of claim 11, wherein the machine learning model includes a k-modes model.

14. The method of claim 13, further comprising using the artificial intelligence engine to use the machine learning model to identify a range of clustering models to be selected for data records of the plurality of data records based on a sum of squares function.

15. The method of claim 14, further comprising classifying, using the artificial intelligence engine using the machine learning model, data records of the plurality of data records into test data clustering models based on the range of clustering models.

16. The method of claim 9, wherein the test data clustering models are correlated with existing test case scenarios.

17. An apparatus for automatically identifying test case data, the apparatus comprising:
a processor; and
a memory including instructions that, when executed by the processor, cause the processor to:
receive a plurality of data records from one or more data producer applications;
classify, using an artificial intelligence engine that uses a machine learning model configured to classify data records, data records of the plurality of data records into test data clustering models;
receive input indicating one or more test case requirements;
generate, based at least on the one or more test case requirements and the test data clustering models, at least one test case blueprint indicating at least one test data clustering model that corresponds to the one or more test case requirements;
in response to instructions to perform a data test corresponding to the test case requirements, use the at least one test case blueprint to populate test case data using data records corresponding to the at least one test data clustering model indicated by the at least one test case blueprint;
train the machine learning model using feedback corresponding to the performed data test; and
in response to receiving subsequent data records from the one or more data producer applications, classify, using the artificial intelligence using the machine learning model, the subsequent data records into the test data clustering models.

18. The apparatus of claim 17, wherein the machine learning model includes an unsupervised learning machine learning model.

19. The apparatus of claim 18, wherein the machine learning model includes a k-means model.

20. The apparatus of claim 18, wherein the machine learning model includes a k-modes model.
